(19) United States
(12) Patent Application Publication
(10) Pub. No.: US 2023/0365819 A1
(43) Pub. Date: Nov. 16, 2023

(54) EFFECTS OF INTERCHAIN CROSSLINKING BY ALKYL DIHALIDES ON THE ELECTROCHEMICAL PERFORMANCE OF NANO-SCALE POLYPYRROLE FILMS

(71) Applicant: The Curators of the University of Missouri, Columbia, MO (US)

(72) Inventors: Ryan Gettler, Columbia, MO (US); Matthias J. Young, Columbia, MO (US)

(21) Appl. No.: 18/315,965

(22) Filed: May 11, 2023

Related U.S. Application Data
(60) Provisional application No. 63/364,533, filed on May 11, 2022.

(51) Int. Cl. C09D 5/44; C09D 7/63; H01M 4/04

(52) U.S. Cl. CPC C09D 5/4461; C09D 7/63; H01M 4/0407; H01M 2004/028

(57) ABSTRACT

Disclosed are the electrochemical effects of crosslinking polymer chains in nanoscale polypyrrole films with aliphatic ethyl (Ppy-Et), propyl (Ppy-Pr), and butyl (Ppy-Bu) groups were investigated. The films are synthesized by pulsed-electrodeposition of polypyrrole followed by a crosslinking reaction with an alkyl dihalide (dibromoethane, dibromobutane, or dibromopropane) in methanol. By changing the length of the alkyl-dihalide crosslinker, it was shown that one can adjust the properties of the polypyrrole films to achieve properties not typical for polypyrrole. The resulting materials exhibit valuable properties in two areas: (1) excluding anions from transport through the polymer, allowing for the creation of cation-selective membranes using polpyrrole crosslinked with ethyl (2 carbon) crosslinker molecules and (2) enhancing the specific capacity by >50% relative to the uncrosslinked polymer using propyl (3 carbon) crosslinker molecules. These materials have potential value for energy storage, electrochemical desalination, membrane separations, and chemical sensors.

### CROSS REFERENCE TO RELATED APPLICATIONS

This application claims the benefit of U.S. Provisional Application No. 63/364,533, filed May 11, 2022, the contents of which are incorporated by reference herein in their entirety.

### STATEMENT REGARDING FEDERALLY SPONSORED RESEARCH OR DEVELOPMENT

This invention was made with government support under Awards G16AP00066 and G21AC10446 awarded by the U.S. Geological Survey. The government has certain rights in the invention.

### FIELD OF INVENTION

The present disclosure provides nanoscale polypyrrole films crosslinked by alkyl dihalides. These films have electrochemical properties suitable for use in nitrate sensors to assess levels of fertilizer pollution in water sources.

### BACKGROUND OF INVENTION

Materials that undergo electrochemical reactions in aqueous electrolytes are valuable for safe and low-cost energy storage, for electrochemical water desalination, and for chemical sensors. Although a range of inorganic materials have promising properties for these applications, inorganic materials are often unstable in aqueous electrolyte and undergo decomposition reactions to dissolve into solution. Redox-active conjugated polymers have attracted interest as electrode materials for these aqueous applications due to their high theoretical charge storage capacities, relatively low cost, and stable cycling behavior. Conjugated polymers such as polyethylenedioxythiophene (pEDOT), polypyrrole (Ppy), and polyaniline (PANT) exhibit high electrochemical capacities, making them appealing as electrode materials for energy storage, electrochemical desalination, and chemical sensing. Heteroatoms in these polymers undergo reversible electrochemical redox reactions to switch between lone-pair and cation-radical configurations, yielding high electrochemical capacity. These redox reactions also produce charge carriers (electrons and holes) that travel down the conjugated backbone of these polymers to produce high electronic conductivities of 100-6,000 S/cm. Following the recent demonstration of desalination batteries and anion-based batteries, these conjugated polymers are also of interest for their ability to reversibly bind anions from solution during electrochemical cycling.

Polypyrrole (Ppy) is one example from this class of conjugated heteroatom containing conductive polymers or copolymers. Ppy is an appealing redox-active conjugated polymer that exhibits high electrical conductivity (100-300 S/cm) and charge storage capacity (100-600 F/g) and is stable in aqueous solutions at pH's from −0.6 to 12 making it an ideal polymer for aqueous electrochemical device applications. Ppy was discovered more than 100 years ago, and Ppy films have been demonstrated in gas and ion sensors, cathode materials for improved batteries, and membrane materials for separations.

The valuable electrochemical properties of Ppy arise from its conjugated molecular structure depicted in FIG. 1A, containing secondary amines embedded within chains of 5-membered pyrrole rings. Under oxidizing (e.g. positive electrical potential) conditions, lone-pairs on amines within Ppy give up one electron to form positively charged cation radical amines as depicted in FIG. 1B. These cation radicals coulombically attract negatively charged cations from the electrolyte, which incorporate into Ppy to balance charge. During electrochemical charge/discharge cycling, this reversible cation-radical/lone-pair process leads to reversible binding and releasing of anions from the electrolyte as depicted in FIGS. 1A and 1B, making these materials of interest as anion-insertion electrodes for aqueous desalination and as anion-insertion cathodes for aqueous dual-ion batteries. The presence of cation radicals distributed along the Ppy backbone also facilitates rapid transport of anions through the Ppy polymer network, and excludes positively charged cations, producing an anion transference number of 0.97.

Either before or after polymerization, amines within pyrrole monomers can be alkylated using alkyl halides as depicted in FIG. 1C. Prior work has studied the use of short-chain alkylation to improve the ability to solution-process Ppy. Alkylation makes Ppy more hydrophobic/nonpolar, thereby increasing the solubility in nonpolar organic solvents and improving stability in aqueous electrolytes. In addition to impacting the solubility of these polymers in different solvents, these alkylation reactions also displace protons from the secondary amines within each Py monomer. Substituting amine protons with alkyl ligand prevents chemical or electrochemical deprotonation of the amine group, thereby improving chemical stability under basic pH's, and improving electrochemical stability.

In this disclosure, bifunctional alkyl halides of various alkyl chain length are employed to crosslink adjacent polymer chains in nanoscale Ppy films and thicker (up to ˜10 μm). Specifically, the crosslinking of Ppy chains with aliphatic ethyl (Ppy-Et), propyl (Ppy-Pr), and butyl (Ppy-Bu) groups using dibromo-alkane crosslinkers is studied as depicted in FIG. 1D. This process is expected to generate hyperbranched Ppy structures that are highly interconnected. Hyper-crosslinked polymers have been reported in recent years to exhibit improved surface area and sorption properties relative to conventional polymers. The original hypothesis that motivated the study of crosslinking Ppy films was that establishing hyperbranched networks within Ppy in the presence of a specific anion (e.g. nitrate) would template ion-specific sites into the polymer and yield ion size-selectivity. However, during this research, an unexpected electrochemical response was discovered, and it was identified that the crosslinker chain length has a dramatic impact on the qualitative electrochemical performance of Ppy films, as is described in detail in the rest of this disclosure. The benefits observed from using these alkylene groups to control the pore diameters within conjugated polymers and alter electrochemical properties are thought to be general for heteroatom containing conjugated polymers.

### SUMMARY OF INVENTION

The present disclosure provides an electrochemical device comprising a conductive substrate coated with a film comprising a conducting polymer crosslinked with a linker, wherein the conducting polymer film comprises an ion, and a branched network having pores.

Another aspect of the disclosure is an ion sensor comprising the electrochemical device.

A further aspect of the disclosure is a method of producing the electrochemical device comprising the conductive substrate coated with the film comprising the conducting polymer crosslinked with the linker, the method comprising:
a) preparing a solution of a conducting monomer and an anion in deionized water;
b) electrodepositing the conducting monomer as a film on the conductive substrate; and
c) reacting the film with a crosslinker.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A depicts how Ppy contains conjugated π network for electron transport.

FIG. 1B depicts how Ppy contains amines with lone pairs that undergo oxidation to form cation radicals.

FIG. 1C depicts how amines within Ppy are also susceptible to alkylation using alkyl halides.

FIG. 1D depicts how Ppy are susceptible to alkylation using alkyl halides, allowing for interchain crosslinking using bifunctional alkyl halides.

FIG. 1E depicts a schematic of the general experimental protocol.

FIG. 1F depicts, from left to right, Ppy-Et, Ppy-Pr, and Ppy-Bu with a nitrate ion.

FIG. 2A depicts changes in voltage with time for a 40 nm thick Ppy film in 0.1 M NaNO₃ obtained by cyclic voltammetry (CV) at 50 mV/s sweep rate. First and third highlighted regions correspond to mass/charge characteristics consistent with anion-insertion behavior, while the second and fourth highlighted regions correspond to mass/charge characteristics consistent with cation-insertion behavior.

FIG. 2B depicts changes in current with time for a 40 nm thick Ppy film in 0.1 M NaNO₃ obtained by CV at 50 mV/s sweep rate. First and third highlighted regions correspond to mass/charge characteristics consistent with anion-insertion behavior, while the second and fourth highlighted regions correspond to mass/charge characteristics consistent with cation-insertion behavior.

FIG. 2C depicts changes in mass with time for a 40 nm thick Ppy film in 0.1 M NaNO₃ obtained by CV at 50 mV/s sweep rate. First and third highlighted regions correspond to mass/charge characteristics consistent with anion-insertion behavior, while the second and fourth highlighted regions correspond to mass/charge characteristics consistent with cation-insertion behavior.

FIG. 2D depicts changes in charge with time for a 40 nm thick Ppy film in 0.1 M NaNO₃ obtained by CV at 50 mV/s sweep rate. First and third highlighted regions correspond to mass/charge characteristics consistent with anion-insertion behavior, while the second and fourth highlighted regions correspond to mass/charge characteristics consistent with cation-insertion behavior.

FIG. 3A depicts sample Nyquist plots for a 40 nm Ppy film in 0.1 M NaNO₃. R_{ct} values were calculated by fitting a Randle's circuit depicted in the inset of FIG. 3A to the semi-circle of the Nyquist plot for each potential, with a sample fit shown by the dashed line at −0.7 V vs. SSC.

FIG. 3B depicts changes in R_{ct} as a function of potential for a 40 nm Ppy film in 0.1 M NaNO₃.

FIG. 4 depicts changes in mass and charge during potential cycling from −0.7 to 0.4 V vs. SSC for a 40 nm thick Ppy film. Mass to charge ratios qualitatively consistent with anion (m*ₐₙᵢₒₙ) and cation (m*_{cation}) are taken by the slope of the linear region during oxidation and reduction, respectively.

FIG. 5A depicts voltammograms in 0.1 M NaNO₃ obtained at a sweep rate of 50 mV/s for 20 nm films of Ppy.

FIG. 5B depicts voltammograms in 0.1 M NaNO₃ obtained at a sweep rate of 50 mV/s for 20 nm films of Ppy-Et.

FIG. 5C depicts voltammograms in 0.1 M NaNO₃ obtained at a sweep rate of 50 mV/s for 20 nm films of Ppy-Pr.

FIG. 5D depicts voltammograms in 0.1 M NaNO₃ obtained at a sweep rate of 50 mV/s for 20 nm films of Ppy-Bu.

FIG. 6A depicts voltammograms in 0.1 M NaNO₃ obtained at 10 mV/s for a 20 nm film crosslinked with EtBr₂.

FIG. 6B depicts voltammograms in 0.1 M NaNO₃ obtained at 20 mV/s for a 20 nm film crosslinked with EtBr₂.

FIG. 6C depicts voltammograms in 0.1 M NaNO₃ obtained at 50 mV/s for a 20 nm film crosslinked with EtBr₂.

FIG. 7A depicts density functional theory (DFT) simulated diffusion energies (E) for nitrate traversing through pores formed by crosslinking for Ppy-Et. Distance is defined normal to the plane of structure pore, where the center of the pore is 0 Å. Atoms are represented as follows: C atoms are green, H atoms are pink, N atoms are blue, and O atoms are red. Optimized minimum E's and corresponding positions are shown in red.

FIG. 7B depicts DFT simulated diffusion energies (E) for nitrate traversing through pores formed by crosslinking for Ppy-Pr. Distance is defined normal to the plane of structure pore, where the center of the pore is 0 Å. Atoms are represented as follows: C atoms are green, H atoms are pink, N atoms are blue, and O atoms are red. Optimized minimum E's and corresponding positions are shown in red.

FIG. 7C depicts DFT simulated diffusion energies (E) for nitrate traversing through pores formed by crosslinking for Ppy-Bu. Distance is defined normal to the plane of structure pore, where the center of the pore is 0 Å. Atoms are represented as follows: C atoms are green, H atoms are pink, N atoms are blue, and O atoms are red. Optimized minimum E's and corresponding positions are shown in red.

FIG. 8 depicts specific capacitance measurements from CV in 0.1 M NaNO₃ at 5, 10, 20, 50, and 100 mV/s. Error bars are representative of two 20 nm replicate films per alkyl dihalide and sweep rate v.

FIG. 9A depicts separation of capacitive and diffusive currents for 20 nm films in 0.1 M NaNO₃ and shows a log-log plot of average current iₐᵥ with sweep rate v. Expected trends for purely capacitive and purely diffusive currents have been included as dashed lines.

FIG. 9B depicts separation of capacitive and diffusive currents for 20 nm films in 0.1 M NaNO₃ and shows f_{d} values calculated from the slopes obtained in panel (a) with average capacities measured at a sweep rate of 10 mV/s.

FIG. 10A depicts a schematic of the intrachain crosslinking in Ppy-Et calculated using DFT. Carbons in the crosslinker chain are denoted numerically for visualization.

FIG. 10B depicts a schematic of the intrachain crosslinking in Ppy-Pr calculated using DFT. Carbons in the crosslinker chain are denoted numerically for visualization.

FIG. 10C depicts a schematic of the intrachain crosslinking in Ppy-Bu calculated using DFT. Carbons in the crosslinker chain are denoted numerically for visualization.

FIG. 11 depicts a model of how nitrate can be trapped in these polymers.

FIG. 12A depicts molecular layer deposition (MLD) growth of redox polymer.

FIG. 12B depicts template polymer with nitrate.

FIG. 12C depicts use as a nitrate sensor.

FIG. 13A, FIG. 13B, and FIG. 13C depict the strategy for generating and evaluating nitrate-selective electrode materials for use in nitrate sensors.

FIG. 14 depicts synthesis steps for forming templated conjugated amine polymer (CAP) films. Each of these reaction steps is expected to depend on the chemical environment during reaction, and key reaction parameters will be evaluated.

FIG. 15A depicts a custom reactor for gas-phase oMLD growth with SS substrates and QZE substrates with electrochemical cells used for evaluation of SS and QZE substrates.

FIG. 15B depicts a custom reactor for gas-phase oMLD growth with SS substrates.

FIG. 15C depicts a custom reactor for gas-phase oMLD growth with QZE substrates.

FIG. 16 depicts a diagram of comb chips used for evaluation of electrical conductivity of CAP films.

FIG. 17 depicts a demonstration of linear growth of polypyrrole CAP using MLD.

FIG. 18 depicts the results of CV in 0.1M NaNO₃ (pH=8) at a scan rate of 50 mV/s.

FIG. 19 shows a CV at 50 mV/s and depicts how addition of a small amount of HNO₃ to the NaNO₃ solution drastically increases the current response.

FIG. 20 depicts CV's at 50 mV/s in 0.1 M NaNO₃, 0.1 M NaCl, and 0.1 M Na₂SO₄ at approximately neutral pH. Nitrate is green, chloride is black, and sulfate is blue.

FIG. 21 depicts a CV at 50 mV/s of the film in 0.1 M NaNO₃ after it has been cycled in nitrate, acidified nitrate, chloride, and sulfate solutions.

FIG. 22 depicts how removal of base from the reaction mixture appears to reduce film performance.

FIG. 23 depicts changes in relative mass specific charge capacity Q with CV cycle. Shaded regions indicate standard deviations of two replicate crosslinked films and uncrosslinked controls.

### DETAILED DESCRIPTION OF INVENTION

Nanoscale films of redox-active amine polymers such as polypyrrole (Ppy) are of interest for aqueous energy storage, water treatment, and chemical sensors. Unfortunately, the electrochemical properties of Ppy are constrained by the local material structures that form during typical synthesis. This disclosure examines how crosslinking Ppy post-synthesis with short-chain bifunctional alkyl-halide crosslinkers influences the charge storage properties of Ppy. Specifically, dibromoethane (EtBr₂), dibromopropane (PrBr₂), and dibromobutane (BuBr₂) crosslinkers were employed to link amines from adjacent Ppy polymer chains in nanoscale Ppy films formed by electrodeposition. The electrochemical performance of the resulting structures was studied using electrochemical quartz crystal microbalance (EQCM) complemented by density functional theory (DFT) studies. It was identified that the shortest (ethyl) crosslinker sterically traps free anions from the electrolyte within the Ppy structure. These trapped anions lead to a qualitative shift in the electrochemical mechanism from anion-insertion to cation-insertion behavior. It was identified that the propyl crosslinker, with just one carbon more than ethyl, allows for more rapid anion motion than intrinsic Ppy, accessing electrochemical capacities up to 60% higher than with no crosslinker. These results reveal the strong impact of local molecular structure on electrochemical properties of redox-active polymers and demonstrate the use of short-chain bifunctional crosslinkers to control their qualitative electrochemical response.

Described herein are various electrochemical devices comprising a conductive substrate coated with a film comprising a conducting polymer crosslinked with a linker, wherein the conducting polymer film comprises an ion, and a branched network having pores.

The conducting polymer of the electrochemical device can comprise a polymer derived from a monomer having a double bond and a heteroatom. Preferably, the heteroatom contained in the monomer is nitrogen, oxygen, or sulfur.

The conducting polymer of the electrochemical device can comprise polypyrrole, polyaniline, polythiophene, poly(3,4-ethylenedioxythiophene) (PEDOT), poly(phenylenediamine), poly(benzene-triamine), polyethylenediamine, polyhydroquinone, polybenzoquinone, polybenzenethiol, polybenzenedithiol, polybenzenetrithiol, polyfuran, or a combination thereof.

Preferably, the conducting polymer comprises polypyrrole or alternately, the conducting polymer comprises polyaniline.

The linker can comprise a C₂-C₈ compound comprising single, double, triple bonds, or a combination thereof, and optionally a heteroatom.

The linker heroatom can preferably be nitrogen, oxygen, or sulfur.

Preferably, the linker comprises an alkylene or arylene moiety.

The alkylene moiety that crosslinks the conducting polymer can comprise ethylene, propylene, butylene, pentylene, hexylene, heptylene, octylene; or a combination thereof; preferably, the alkylene moiety comprises ethylene, propylene, butylene, or a combination thereof; more preferably, the alkylene moiety comprises ethylene or propylene.

The film coating the conductive substrate can have a thickness of from about 1 nm to about 10 μm thick; from about 1 nm to about 5 μm thick; from about 1 nm to about 2 μm thick; from about 1 nm to about 1 μm thick; from about 1 nm to about 800 nm thick; from about 1 nm to about 600 nm thick; from about 1 nm to about 400 nm thick; from about 1 nm to about 200 nm thick; from about 1 nm to about 100 nm; from about 20 nm to about 80 nm; from about 30 nm to about 60 nm; or about 40 nm.

The electrochemical devices described herein can have the conductive substrate be coated with the conducting polymer film that comprises an ion, wherein the ion is an anion and the anion comprises nitrate, chloride, fluoride, bromide, iodide, phosphate, acetate, arsenate, perchlorate, sulfate, glyphosate, hexafluorophosphate, tetrafluoroborate, bis(fluorosulfonyl)imide (FSI), bis(trifluoromethylsulfonyl)imide (TFSI), or a combination thereof; preferably, the anion comprises nitrate.

The electrochemical devices described herein can have the conductive substrate be coated with the conducting polymer film that comprises an ion, wherein the ion is a cation and the cation comprises sodium, lithium, potassium, protons, magnesium, calcium, aluminum, ammonium, alkylated ammonium cations, zinc, copper, manganese, iron, cobalt, nickel, tin, strontium, another monovalent, divalent, or trivalent transition metal cation, or a combination thereof; preferably, the cation comprises sodium, lithium, potassium, protons, magnesium, calcium, aluminum, ammonium, alkylated ammonium cations, zinc, copper, manganese, iron, cobalt, nickel, tin, or strontium.

The electrochemical devices described herein can have anion diffusion be hindered in the film compared to a film comprising a conducting polymer that is not crosslinked.

For the electrochemical devices described herein, the conductive substrate can comprise gold, platinum, silver, copper, nickel, carbon, carbon fiber, graphite, stainless steel, aluminum, steel, titanium, vitreous carbon, carbon black, activated carbon, pyrolytic graphite, palladium, zinc, lithium metal, sodium metal, potassium metal, or a combination thereof; preferably, the conductive substrate comprises gold.

These electrochemical devices can be used for (1) ion sensing, (2) controlled release, (3) energy storage, (4) separations, (5) ion selective membranes, and other purposes.

The properties of the films comprising conductive polymers crosslinked with alkylene groups are described below.

The reaction of nanoscale Ppy films with alkyl dihalide crosslinkers as a simple way to alter the electrochemical properties of the native Ppy polymer is reported. Crosslinking polymer chains with ethyl substituents (Ppy-Et) produces local microstructures that severely limit the transport of anions through the Ppy and switches the charge balance mechanism from anion-mediated to cation-mediated behavior during potential cycling. This effect is analogous to previous reports of cation-mediated behavior in Ppy when incorporating copolymers with structural anions, but here arises from free ions that are kinetically/sterically trapped within the crosslinked Ppy structure. This provides a route for the synthesis of cation-insertion polymers using polymers that would typically be expected to reversibly insert anions. The resulting films have application as cation-selective electrode for ion removal in electrochemical desalination, as cation-selective membranes, and as a low-resistance membrane material for electrodialysis.

It was found that linking Ppy chains with propyl crosslinker units (Ppy-Pr)—only one carbon longer than the ethyl crosslinker—promotes transport of ions through the polymer matrix. This leads to an increase in electrode kinetics and specific capacitance over intrinsic electrodeposited Ppy. Here, the Ppy-Pr films exhibit electrochemical capacities of up to 723 F/g (221 mAh/g), which are 80-600% higher than values of 100-400 F/g (140 mAh/g) typically reported for Ppy. This suggests that opening the pore structure of Ppy using crosslinkers comprised of three or more carbon atoms not only enhances ion mobility, but also increases the availability of active amine sites within the Ppy to coordinate with anions and undergo electrochemical redox reactions. Ppy-Pr could be useful as a supercapacitor or cathode material.

Ppy-Bu films would be expected to exhibit a more open pore structure than Ppy-Pr, however, the intrachain reaction with the butyl crosslinker likely competes with the desired interchain reaction and does not as effectively open the Ppy pore structure. As such, the properties of Ppy-Bu are more in line with those of intrinsic electrodeposited Ppy.

The simple process using short-chain crosslinkers to qualitatively change the electrochemical response of Ppy underscores the importance of local molecular structure on the electrochemical properties of polymers. Electrochemical degradation and structural (pore) collapse are a pervasive problem for Ppy in general, and thus Ppy devices often have short lifetimes. This work provides an orthogonal approach to crosslinking using formaldehyde dimethyl acetal (FDA) crosslinkers for single-carbon hyper-crosslinking and provides a route to easily control the chain length and pore size in polymers. Future studies will extend this concept and use short-chain crosslinkers to control the electrochemical properties of other polymers.

### Nitrate/Anion Sensors

The electrochemical devices described herein can have the electrochemical device be an electrode.

Further, an ion sensor can comprise the electrochemical device or electrode described herein.

For the ion sensors described herein, the ion can be an anion and comprise nitrate, phosphate, arsenate, pertechnetate, uranate, glyphosate, perfluorooctylsulfate (PFOS), or perfluorooctanoate (PFOA); preferably, the anion comprises nitrate.

Additionally, for the ion sensors described herein, the ion can be a cation and comprises sodium, lithium, potassium, or another monovalent cation; preferably, the cation comprises sodium, lithium, or potassium.

The ion sensors described herein can have the electrochemical device be a comb-chip electrode.

Each year over $100 million worth of nitrogen fertilizer is lost to water runoff and collects in water resources, causing harmful algal blooms that damage the environment and lead to economic losses to waterfront communities. Nitrogen from fertilizer is lost to water runoff in the form of nitrate (NO₃⁻) and is accumulating in water resources—causing financial losses for farmers, disturbing environmental ecosystems, and negatively impacting human health and small-town tourism economies. In 2017, Missouri provided 6.7% of the U.S. soybean supply and 3.7% of the U.S. corn supply, amounting to a >$4 billion agriculture industry in Missouri from these two crops alone. To generate these crops, each year Missouri farmers spend $300-500 million dollars on an average of ˜400,000 short tons of nitrogen-enriching fertilizer. Of this, less than half of nitrogen is recovered in crops and an estimated >40% of nitrogen is washed away from rainfall, corresponding to hundreds of millions of dollars of financial losses to Missouri farmers.

Unfortunately, this lost nitrogen also accumulates in lakes and ponds in Missouri and contributes to harmful algal blooms that disrupt the environmental ecosystems in these water resources and put human health at risk. In order to prevent nitrate loss and its potential harmful effects there is a need to better understand when, where, and how nitrate is released from agricultural sources and transported to Missouri water resources. The key barrier to this understanding is the lack of availability of low-cost and high-accuracy nitrate sensors. Development of advanced nitrate-selective materials which can be used in low-cost nitrate sensors to understand the release and transport of nitrogen with higher spatial and temporal resolution over existing methods is needed.

In order to mitigate these harmful effects, one needs to better understand how nitrogen from fertilizer is lost and transported in the environment. Conventional methods for detecting nitrogen in water or soil samples rely on slow and costly laboratory measurements, most commonly liquid chromatography-mass spectrometry (LC-MS) methods, which cannot provide a clear picture of how nitrogen moves through the environment. For these studies, field samples are taken and brought back to a laboratory, where a scientist or technician performs measurements to determine the nitrate content of these water samples. This laboratory measurement approach has been successful, but has limitations in sampling frequency and throughput. There is a need to develop low-cost and high accuracy nitrogen sensor technologies for distributed use. The current state-of-the-art for such a sensor is limited by poor electrical conductivity and limited thickness control of the nitrate-sensing material, and provides only ˜1 mg/L nitrate sensitivity, versus ˜0.1 pg/L sensitivity for LC-MS. Nitrate-sensing materials based on electrically-conducting polymer thin films that provide higher selectivity and sensitivity to nitrate are disclosed. The materials science advances generated from the proposed work promise to enable distributed sensors for nitrate detection, ultimately enabling high spatial and temporal resolution of nitrate field data in water, even enabling real-time data monitoring of nitrate release in line with efforts such as EARTHDATA from NASA and the various real-time Data and Tools resources available from USGS.

Improved selectivity and sensitivity of the impedance detection method for sensing nitrate is needed and can be accomplished by employing a materials platform for templating anion-selective electrodes based on electrically-conductive polypyrrole. A nitrate-sensing polymer is needed with enhanced electrical conductivity which is uniformly and conformally coated onto the sensor detection area.

An objective described herein is development of a means to template electrically conducting polymers to provide higher nitrate sensitivity. Prior work has demonstrated the ability to fabricate cation-selective polymeric electrodes by templating cation-specific sites using crown-ether reagents. The procedure used to generate cation-selective electrodes employ cations coordinated with crown-ether ligands which incorporate into a polymeric support to form sites specific to that individual cation. Select studies have also demonstrated a similar concept for templating anion-specific sites into polymers, where nitrate is coordinated to thiourea and crosslinked into a polymer network.

In this case, the ion templating method would use thin film, electrically-conducting electrodes by electrochemically inserting nitrate into the polymer, and then crosslinking the conducting polymer chains to generate sites specific to nitrate. Important characteristics of the method is to control thickness and electrical conductivity of the conducting polymer film that can provide higher sensitivity and selectivity toward nitrate. Additionally, the proposed anion templating platform can be used to generate materials to selectively bind other anions, and these materials could be scaled up in volume and used to selectively remove these anions rather than just detect them.

CAPs are proposed to be used as a platform for generating nitrate-selective electrodes because CAPs are electrically conductive and electrochemically inserts anions. Few materials are known which electrochemically insert anions. Of these, CAPs are the most robust and well-studied, with studies of polyaniline and polypyrrole. Herein is described synthesis of the CAP films to incorporate anion-specific sites in the polymer structure which are locked in place through polymer crosslinking. These sites are expected to be more selective to nitrate, and more robust against structural reorganization, ultimately providing higher detection efficiency.

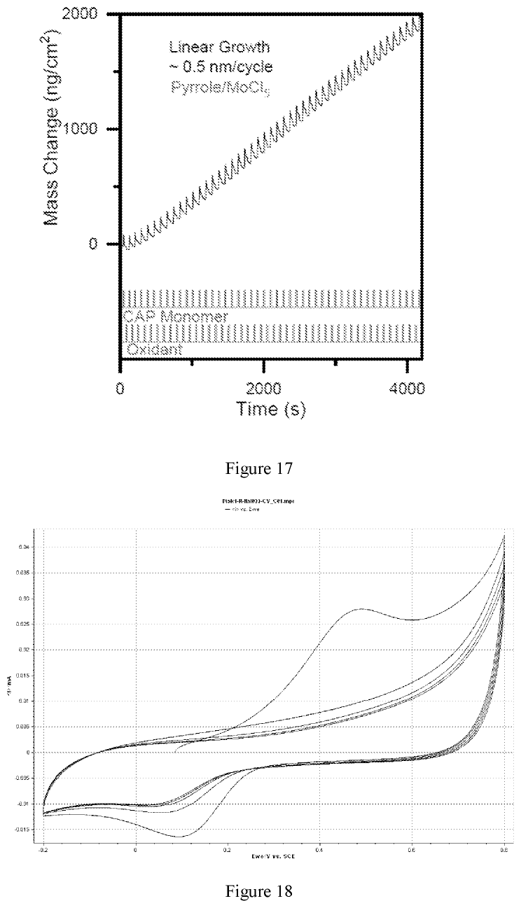

The proposed approach also employs molecular layer deposition (MLD) to provide pristine control of film thickness of the nitrate-sensing material. This allows one to study how thickness of the CAP film influences sensor performance with sub-nanometer precision. The proposed work would be the first attempt to use the MLD-grown polymer films to generate nitrate-specific materials. Here, MLD of N-containing CAPs will be employed, where N-groups provide higher ion binding capacities (>500 F/g45-47 up to 2000 F/g, 44) while retaining high electrical conductivity (580 S/cm). The secondary amine (N) groups in the CAP backbone also allow for convenient reaction sites for crosslinking chemistries to introduce selectivity. MLD of N-containing CAPs has been established previously as depicted in FIG. 17. The proposed work will build off of ongoing MLD work to fabricate nitrate-templated thin films as described above.

The proposed research project aims to address these needs and develop a concept for templating nitrate-selective sites into electrically-conductive and redox-active conjugated amine polymer (CAP) thin films (e.g. polypyrrole) which are conformally coated onto sensor substrates using molecular layer deposition (MLD). An understanding of how various aspects of the proposed polymer templating procedure impact selectivity and sensitivity toward nitrate will be developed. The findings will provide the fundamental basis needed to inform the controlled synthesis of advanced nitrate-selective materials to be used in low-cost electrical nitrate sensors.

The nitrate sensing materials must be able to withstand mild to moderate pH ranges (both acidic and basic), be resistant to poisoning and/or false positives from competitive sorption of the other ions found in the environment, and provide high accuracy and sensitivity down to <1 μg/L of nitrate.

The proposed conjugated amine polymer (CAP) thin films will act as a platform to generate nitrate-selective materials to meet these target properties. CAPs are electrically conductive and redox-active—binding negatively charged anions (such as nitrate) under applied potential. The proposed CAPs are stable and redox-active at pHs from 4-11, with electrical conductivities >500 S/cm. These characteristics make CAPs a well-suited materials platform to generate nitrate-selective materials for electrochemical sensors.

The proposed approach employs precision synthesis of nitrate-sensing materials by (a) growth of redox-active and electrically-conducting polypyrrole with sub-nanometer thickness control using molecular layer deposition (MLD) and (b) introducing nitrate-specific sites in these polypyrrole thin films by impregnating the polymer with nitrate (NO₃⁻), and then crosslinking the polymer in place around the nitrate. This approach will generate nitrate-selective polyporrole thin films of 1-100 nm thickness. The use of a thin-film electrically conductive material is expected to provide many orders of magnitude (>10¹⁰) higher electrical conductance to the nitrate-selective sites in the sensing material and enable low-cost sensors to achieve performances closer to that of LC-MS.

The electrochemical devices described herein can also be a cathode.

The electrochemical devices that are electrodes or cathodes can also be used in a battery.

When the electrochemical devices are electrodes or cathodes used in a battery, the battery comprises a housing, the cathode described herein, an anode, an electrolyte, and a separator. The cathode and anode are in electrical connection with the electrolyte and the separator is located between the cathode and anode. The cathode, anode, electrolyte, and separator are disposed within the housing.

The electrochemical devices herein can also be a supercapacitor. The supercapacitor is a low voltage component and can be used in applications requiring many rapid charge/discharge cycles. They can be used in regenerative braking for automobiles, buses, trains, cranes, and elevators. Supercapacitors are also used for short-term energy storage and burst-mode power delivery. The typical design of a supercapacitor includes a two electrodes separated by a separator (e.g., ion-permeable membrane). When the electrodes are polarized by an applied voltage, ions in the electrolyte form electric double layers of opposite polarity to the electrode's polarity. For example, positively polarized electrodes will have a layer of negative ions at the electrode/electrolyte interface and a charge-balancing layer of positive ions adsorbing onto the negative later. The opposite is true for the negatively polarized electrode.

The electrochemical devices described herein can be prepared by (a) preparing a solution of a conducting monomer and an ion in deionized water; (b) electrodepositing the conducting monomer as a film on the conductive substrate; and (c) reacting the film with a crosslinker.

The crosslinker can comprise a dihalo-alkane crosslinker or a dihalo-benzene crosslinker.

The method for making the electrochemical devices can further comprise one or more wash steps. The wash steps use methanol, deionized water, or a combination thereof.

Additionally, the method for making the electrochemical devices can also comprise drying the electrode with argon.

These methods of making the electrochemical devices can have the dihalo-alkane crosslinker comprise dibromoethane, dichloroethane, diiodoethane, dibromobutane, dichlorobutane, diiodobutane, dibromopropane, dichloropropane, or diiodopropane.

Also, the methods for making the electrochemical devices can have the electrodeposition step (b) comprise applying 0.7 V vs SSC for 1.5 s, followed immediately by a 1.5 s relaxation at 0.0 V vs SSC, performed one or more times to achieve a desired film thickness.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used in this application, including the appended claims, the singular forms “a,” “an,” and “the” include plural references unless the content clearly dictates otherwise, and are used interchangeably with “at least one” and “one or more.”

The invention will be further described in the following examples, which do not limit the scope of the invention described in the claims.

### EXAMPLES

It is to be understood that while the invention has been described in conjunction with the detailed description thereof, the preceding description is intended to illustrate and not limit the scope of the invention, which is defined by the scope of the appended claims. Other aspects, advantages, and modifications are within the scope of the following claims.

### Example 1: Materials and Methods

### I. Electrochemical Characterization

Electrochemical characterization was performed using a standard three electrode cell with a 6 mm diameter Ag/AgCl (SSC) reference electrode (BASi) and a 6 mm diameter graphite rod counter electrode (99.999%, Alfa Aesar). The working electrode consisted of a gold coated AT-cut quartz crystal (5 MHz, Phillip Technologies) mounted on a QCM-200 controller (Stanford Research Systems). Electrochemical data acquisition and analysis were conducted using a Biologic SP-150 potentiostat interfaced with EC-Lab software. All solutions were purged with argon gas (99.999%, Airgas) for at least 10 minutes before experimentation, and a steady flow of argon was applied to the head space of the cell for the duration of each experiment. Cyclic voltammetry (CV) characterization was employed at various sweep rates from −0.7 to 0.4 V vs SSC for a minimum of 4 complete cycles. Electrochemical impedance spectroscopy (EIS) spectra were obtained using a 10 mV amplitude over a 100 mHz-1 MHz frequency range. Charge transfer resistance was calculated by fitting a Randle's circuit to the impedance data.

### II. Preparation of Ppy Films

Solutions containing 1.0 M pyrrole monomer (99%, Sigma Aldrich) and 0.1 M NaNO₃ (99%, Fisher) were prepared by adding the appropriate amount of each reagent to deionized (DI) water and diluting to the desired volume. Films were deposited on the working electrode using a pulsed deposition technique established previously (Gettler, R.; Young, M. J. Review of Scientific Instruments 2021; Wyatt, Q. K.; Young, M. J. Journal of The Electrochemical Society 2020, 167, 110548). Here, 0.7 V vs SSC was applied for 1.5 s, followed immediately by a 1.5 s relaxation at 0.0 V vs SSC. This cycle was repeated until an EQCM frequency-decrease was achieved corresponding to a desired film thickness (mass). Following deposition, samples were rinsed with methanol and DI water, dried with argon, and stored at room temperature in the dark to prevent photodegradation until usage. Thickness measurements were obtained via spectroscopic ellipsometry (SE) using an alpha-SE spectroscopic ellipsometer (J. A. Woollam) at a 65° incident angle over a wavelength range of 380-900 nm. SE instrument control and data analysis was performed using the CompleteEASE software. The optical properties of each film were determined by fitting a system of three Gaussian oscillators to the experimental reflection data. All reported SE analysis is representative of three separate measurements at different points on each sample. Film masses were calculated by conversion of the measured changes in EQCM resonant frequencies via the Sauerbrey equation (Equation 1), where Δm is the mass change and ΔF is the change in frequency.

$$Δ m = - \frac{Δ F}{56.6} ( \frac{μ g}{Hz \cdot {cm}^{2}} ) \qquad ( 1 )$$

Select Ppy samples were reacted with EtBr₂ (98%, Sigma Aldrich), PrBr₂ (99%, Sigma Aldrich), or BuBr₂ (99%, Sigma Aldrich) using 10 μL of alkyl dihalide in 1 mL of methanol for 5 minutes. After reaction, the crosslinked samples were rinsed with methanol and DI water and stored in the dark until usage.

### III. DFT Calculations

To understand the energetics for transport of nitrate ions through Ppy crosslinked with either ethyl, propyl or butyl linkers, density-functional theory (DFT) calculations were performed using the GAMES S software package. The final geometric structures from each calculation were visualized using the Avogadro software. Two properties were calculated using DFT studies: (1) the energy barrier for nitrate ion transport through Ppy pores comprised of six Py monomers in three-monomer chains and crosslinked with varying alkyl chain lengths and (2) the total reaction energy for the reaction of each crosslinker molecule on neighbouring Py monomers within a single Ppy chain.

To calculate the energy barrier for nitrate ion transport, a series of constrained geometry optimization calculations were performed for each pore using the B3LYP (Becke, A. D. The Journal of Chemical Physics 1993, 98, 5648-5652) and wB97X-D (Chai, J.-D.; Head-Gordon, M. Physical Chemistry Chemical Physics 2008, 10, 6615) exchange-correlation functionals with the 6-31G(d,p) basis set. Six different constrained geometry optimizations were initially performed with the four carbon atoms (one each per four monomers) that define the polymer ring constrained to lie in the same XY-plane and the nitrogen in the nitrate ion constrained to a z-value between 0.0-5.0 Å (with 1.0 Å spacings) relative to this constrained XY-plane. All non-constrained coordinates were then optimized. Solvent effects were included using the polarized continuum model (PCM) (Mennucci, B. WIREs Computational Molecular Science 2012, 2, 386-404) with parameters for liquid water. Additionally, the lowest energy adduct structure for each pore size was found by starting from the geometry with the lowest energy value from the six initial constrained geometry optimizations and performing an additional constrained geometry optimization where only the four carbon atoms in the polymer ring previously constrained to lie in the XY-plane remained constrained. I.e., for this geometry optimization the nitrogen in the nitrate ion was allowed to move freely. The barrier for the transport of the nitrate ion through the pore was then calculated as the difference of the energy of the final constrained minimum and the energy with the nitrogen ion fixed in the XY-plane (z=0.0 Å).

The total reaction energy of each crosslinker reacting on a single-chain Ppy was also calculated using Equation 2:

Ppy+Br-R-Br →Ppy-R+2 HBr (2)

where, R denotes the ethyl, propyl or butyl functional group. These calculations were performed using the B3LYP exchange-correlation function with the 6-31G(d,p) basis set. Energies were obtained from a geometry optimization for each species using PCM with parameters for liquid water to include solvent effects. After the equilibrium geometries were found, a Hessian was computed for each species at its equilibrium geometry to include zero-point energy effects in the reported total energy values.

### Example 2: Polypyrrole Characteristics

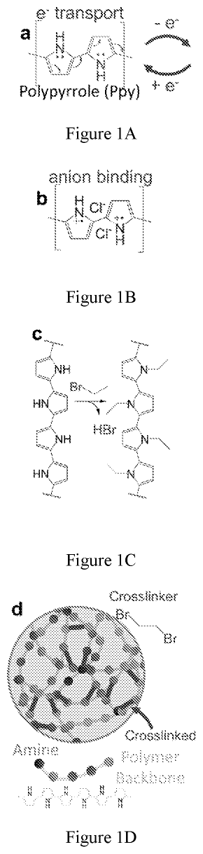

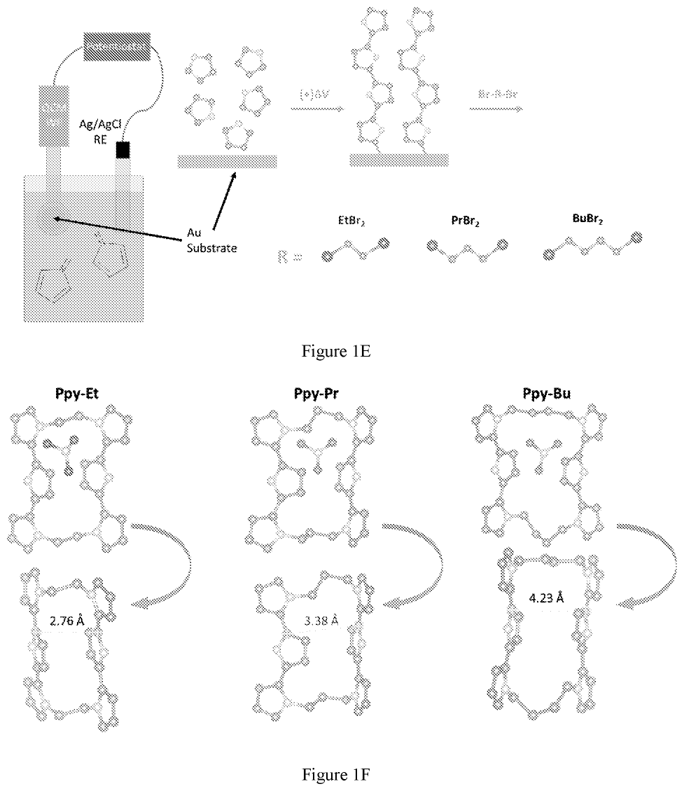

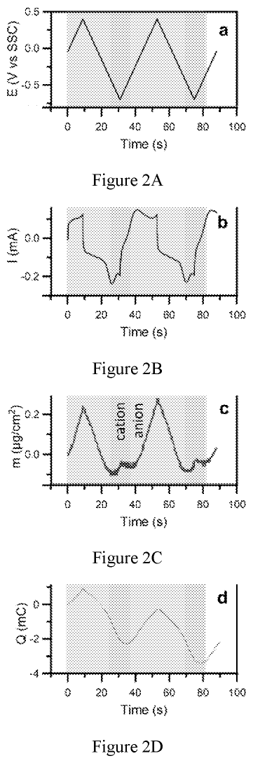

Before examining the effect of interchain crosslinking on electrochemical ion insertion properties of Ppy, the properties of Ppy as-synthesized from electrodeposition are first outlined. The ion insertion/extraction mechanisms of Ppy during electrochemical cycling are well documented and confirmed here using EQCM during a CV experiment on a 40 nm thick electrodeposited Ppy film in FIG. 2A-2D. Here and elsewhere in the disclosure, the Ppy thicknesses are determined from the EQCM mass gain assuming a density of 1.4 g/cm³ for Ppy and verified using ex situ SE measurements. During the electro-polymerization process, the Ppy is doped by nitrate anions from the supporting electrolyte, resulting in an electronically and anionically conductive material which exhibits electrochemical anion exchange on potential cycling. Following electrodeposition, the sample using CV was studied in FIG. 2A-2D. On the oxidizing (anodic) sweep from −0.3 to 0.4 V vs. SSC (corresponding to a time of ˜30-50 s) in FIG. 2A, a positive current of ˜0.15 mA was measured in FIG. 2B. Positive charge accumulates as cation radicals form on the Ppy backbone as depicted in FIG. 1A-1B, and anions in solution diffuse into the film to maintain electrical neutrality. This results in the observed mass increase in FIG. 2C when the potential is swept from −0.3 to 0.4 V. Likewise, on the reducing (cathodic) sweep from +0.4 to −0.3 V vs. SSC (corresponding to a time of ˜50-80 s) in FIG. 2A, a negative current was measured in FIG. 2B. This increase in negative charge reduces the cation radicals on Ppy to form closed-shell lone pairs as depicted in FIG. 1A-1B. With no positive charge to hold anions within the Ppy structure, anions are expelled into the electrolyte, corresponding to the mass decrease in FIG. 2C.

Interestingly, if the potential is sufficiently reducing (≤−0.6 V vs. SSC in FIG. 2), a mass increase is observed on the reducing sweep (e.g. from 25-30 s and 70-75 s in FIG. 2A-2D). Just as a mass decrease during electrochemical reduction is indicative of an anion-mediated process, a mass increase during electrochemical reduction is indicative of a cation-mediated process, which is not intuitive based on the lone-pair/cation-radical electrochemistry expected for Ppy (depicted in FIG. 1A-1B). In FIG. 2A-2B, the data consistent with an anion insertion mechanism are the first and third sections highlighted, and the data consistent with a cation insertion mechanism are the second and fourth sections highlighted. Previous studies have shown that if structural anions are incorporated into the Ppy film during synthesis (e.g. as polystyrene sulfonate (PSS) copolymers), the fixed negative charge counterbalances the cation radicals, and during Ppy electrochemical cycling, the redox processes are instead dominated by cation transport. Based on this, the cation-insertion behavior may arise from some amount of fixed charge (anions) trapped within the Ppy (vide infra), leading to cation-mediated electrochemical activity. However, this mass increase may also arise from the uptake of solvent at a negative overpotential.

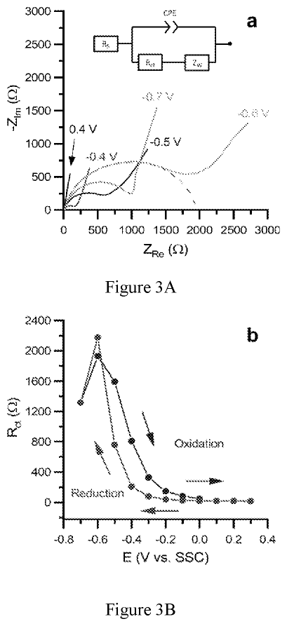

To identify whether cation insertion or solvent uptake is responsible for the mass uptake under over-reduction in FIG. 2A-2D, EIS was performed at 100 mV intervals over the potential range of −0.7-0.4 V vs. SSC as depicted in FIG. 3A, again using a Ppy film of 40 nm thickness. The resistance values presented in FIG. 3B were calculated from the semi-circle of the Nyquist plots in FIG. 3A at each potential (as indicated by a dashed line in FIG. 3A for the −0.6 V vs. SSC potential). The Randle's circuit used to fit these data is depicted in the inset of FIG. 3A. The diameter of the semi-circle along the horizontal real-impedance (ZRe) axis was interpreted as the total specific charge transfer resistance Rct. In the absence of other phenomena, reduction of cation radicals on Ppy to form lone pairs is expected to drive anions out of Ppy and reduce the number of electronic charge carriers, increasing both the electronic and ionic resistance. Therefore, if the mass uptake during over-reduction (the second and fourth highlighted regions in FIG. 2A-2D) was due solely to solvent uptake effects, a steady decrease in Rct would be expected as the potential becomes more negative. In contrast, an influx of cations into Ppy from the electrolyte would be expected to increase the ionic conductivity of the film and reduce the measured Rct. Thus, the EIS measurements in FIG. 3A can be interpreted to identify if cation insertion is contributing to the behavior highlighted in the second and fourth regions in FIG. 2A-2D. In FIG. 3A-3B, which observe a gradually increasing resistance as the potential steps from +0.3 to −0.6 V vs. SSC—consistent with the behavior expected for lone-pair formation and anion expulsion. However, at −0.70 V vs. SSC a distinct drop in Rct was observed despite the polymer being in an un-doped insulating state at this potential. This suggests that some amount of cation insertion/extraction occurs in native Ppy under high reducing potentials (<−0.6 V vs. SSC). As described above, cation insertion behavior has been observed with PSS copolymers where fixed negative charges shift the ion transport mechanism from anions to cations, however PSS is not used in the electrodeposited Ppy film and the origins of a fixed negative charge within intrinsic electrodeposited Ppy structure are unclear.

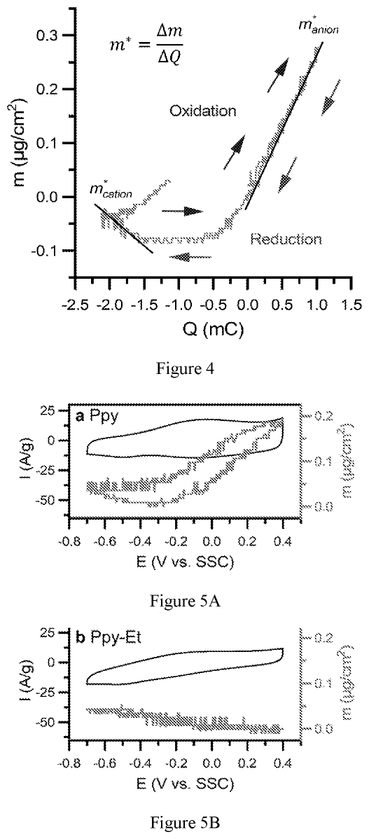

To better quantify the extent of cation vs. anion insertion in intrinsic electrodeposited Ppy, EQCM measurements were employed and the change in mass (m) vs. the amount of charge transferred (Q) to/from the working electrode during potential cycling was plotted in FIG. 4. Here, the mass change (Δm) observed over a discrete change in charge transferred (ΔQ) (i.e. Δm/ΔQ, or the slope of m vs. Q in FIG. 4) reflects the average mass-to-charge ratio for ions diffusing in and out of the film in that region. For single-ion transport in and out of the film (i.e. cation-only or anion-only mechanisms), the mass-to-charge ratio (slope in FIG. 4) should correspond to the ion molar mass used in the electrolyte (e.g. −62 g/z for nitrate and 23 g/z for sodium). However, the ability of Ppy to insert both anions and cations complicates this analysis, as simultaneous insertion/extraction of both cations and anions is possible at each point during the charge-discharge process.

In FIG. 4, separate regions were observed over which qualitative behavior consistent with anion insertion and cation insertion each dominate the EQCM response during electrochemical cycling of Ppy. For values of charge between −0.5 mC and 1 mC in FIG. 4, a positive slope of m vs. Q was observed, indicating an increase in mass upon oxidation—consistent with anion insertion. This region was labeled as m*ₐₙᵢₒₙ. Similarly, for values of charge between −2 mC and −1.5 mC in FIG. 4, a negative slope of m vs. Q was observed, indicating an increase in mass upon reduction—consistent with cation insertion. Linear regression over these regions gives an average m*ₐₙᵢₒₙ of −38.9(±4.9) g/z and m*_{cation} of 6.7(±1.7) g/z, both significantly smaller in magnitude than the values expected for insertion of individual nitrate anions (-62 g/z) and sodium cations (23 g/z). This indicates that cation and anion transport are occurring simultaneously over both regions. In FIG. 4, the mass transfer rate of nitrate anion and sodium cation is equal over charge values from −1.5 mC to −0.5 mC, yielding a flat line in the mass profile. This corresponds to a potential region of −0.2 to −0.5 V vs. SSC. At more oxidizing potentials (in the m*ₐₙᵢₒₙ region) the nitrate mass flux into the Ppy film is greater than the mass flux of sodium, and the observed mass change is anion-dominated. At more reducing potentials, there is a net mass flux of sodium into the polymer, corresponding to the observed mass increase at more negative potentials in the m*_{cation} region. Mass balance is calculated by \dot{m}=\dot{n}ᵢMᵢ+\dot{n}ⱼMⱼ, and charge balance is calculated by

$${\dot{n}}_{e} = {\dot{n}}_{i} {z}_{i} + {\dot{n}}_{j} {z}_{j} = - \frac{\dot{q}}{F} .$$

Combining the mole balance and charge balance for binary transport,

$${f}_{i} = \frac{Δ {n}_{i}}{Δ {n}_{e}} = \frac{{n}_{i} {M}_{i} - {n}_{j} {M}_{j}}{{n}_{i} {z}_{i} - {n}_{j} {z}_{j}} .$$

Then, an expression for the fraction of anion or cation contribution to the observed mass changes during CV was derived (Equation 3).

$${f}_{i} = \frac{{M}_{j} - {z}_{j} {m}^{*}}{{M}_{i} + {M}_{j}} \qquad ( 3 )$$

Here fᵢ is the fraction of coulombic charge-balance attributed to species i, M_{i/j} is the molar mass (62 g/mol for nitrate and 23 g/mol for sodium), and m* is the mass-to-charge ratio (slope) obtained by linear regression of the EQCM data. Employing Equation 2 to analyze the EQCM data in FIG. 4, it was calculated that nitrate is responsible for 73% of the mass transfer during oxidation from 0 to 1 mC (m*ₐₙᵢₒₙ).

This indicates that cation transport out of the polymer reduces m* by ˜17% below its expected value. Using equivalent data analysis, it was calculated that sodium cations are responsible for 81% of the mass transfer during reduction from −1.5 to −2.0 mC. It is noted that these calculations assume no solvent uptake effects.

### Example 3: Properties of Crosslinked Polypyrrole

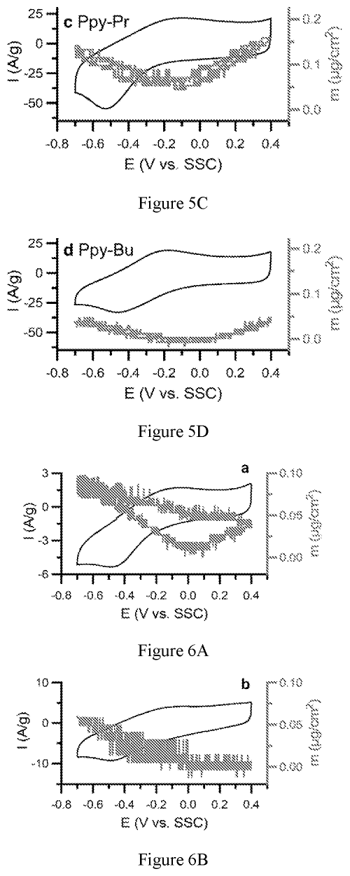

After developing the baseline performance of intrinsic as-deposited Ppy and the data analysis tools employed above, the focus then turned to how crosslinking affects the electrochemical behavior of Ppy. In FIG. 5A-5D, EQCM data for un-crosslinked Ppy (FIG. 5A) was compared against EQCM data for Ppy crosslinked with EtBr₂ (FIG. 5B), PrBr₂ (FIG. 5C), and BuBr₂ (FIG. 5D). Ppy crosslinked with EtBr₂, PrBr₂, and BuBr₂ each exhibit qualitative differences in electrochemical characteristics versus intrinsic electrodeposited Ppy. In FIG. 5A, intrinsic Ppy exhibits behavior consistent with the results presented above in FIGS. 2A-2D and 3A-3B. An increase in mass was observed in FIG. 5A as the potential is swept from −0.2 to +0.4 V vs. SSC (corresponding to anion insertion under oxidation), and a smaller, but still visible increase in mass as the potential is swept from −0.5 to −0.7 V vs. SSC (corresponding to cation insertion under reduction). For Ppy reacted with EtBr₂ (FIG. 5b), this duality of both cation and anion insertion is not present. Surprisingly, a monotonically negative slope in m vs. E was observed during both oxidation and reduction sweeps in FIG. 5B, indicating that sodium cations are dominating the ion insertion behavior when using the EtBr₂ crosslinker. Using a PrBr₂ crosslinker in FIG. 5C, increasing the alkyl linker length by a single carbon causes the positive slope in m vs. E to return during the oxidizing sweep. For the Ppy-Bu in FIG. 5D, mass changes were observed that are approximately equal in magnitude to the Ppy-Pr film during both oxidation and reduction. Employing Equation 3 to examine the mass-to-charge data from 0 to 0.4 V vs. SSC (equivalent to the analysis in FIG. 4 for m*ₐₙᵢₒₙ), it was found that anion-insertion behavior accounts for 17%, 59%, and 53% of the electrochemical behavior for Ppy-Et, Ppy-Pr, and Ppy-Bu, respectively (compared to 73% for intrinsic Ppy reported above). Examining the mass-to-charge data from −0.5 to −0.7 V vs. SSC (equivalent to the analysis in FIG. 4 for m*_{cation}), it was found that cation-insertion behavior accounts for 85%, 80%, and 82% of the electrochemical behavior for Ppy-Et, Ppy-Pr, and Ppy-Bu, respectively (compared to 81% for intrinsic Ppy reported above).

Previous reports have attributed cation insertion behavior in intrinsic Ppy to “structural” anions, negative Mulliken charge density on monomer rings, and immobile anions. If the alkyl-dibromide crosslinkers were reacting to covalently bind anions to the polymer structure and create “structural” anions, or if Mulliken populations were driving cation uptake, it would be expected to see an equivalent change in the electrochemical behavior regardless of the crosslinker chain length. The dependence on the extent of cation-insertion behavior on the crosslinker chain length in FIG. 5A-5D indicates that the anions are not covalently bound to the polymer structure. Instead, it is suggested that anions experience different amounts of steric hindrance to transport based on the crosslinker chain length. Specifically, it is suggested that the bifunctional alkyl crosslinkers form interchain bridges across adjacent Ppy chains and create pores of different dimensions depending on the crosslinker chain length. Interchain crosslinking using the shortest ethyl linker (Ppy-Et) is expected to create the smallest pore sizes and trap nitrate ions in the polymer matrix. A NO₃⁻ ion is 3.58 Å. During electrochemical cycling, more sodium is incorporated into the polymer under reducing potentials to compensate for the increased negative charge of the immobilized nitrate ions and neutralize the charge as observed in FIG. 5B. This mechanism is analogous to the use of PSS to create fixed negative charges, but here the fixed negative charge arises from free anions that are sterically trapped within the polymer matrix. It is expected that anion transport is most restricted in Ppy-Et, where polymer chains are crosslinked with the shortest interchain bridges, and that ion transport is more facile with longer chain lengths in Ppy-Pr and Ppy-Bu, in agreement with the observations in FIGS. 5C and 5D, respectively.

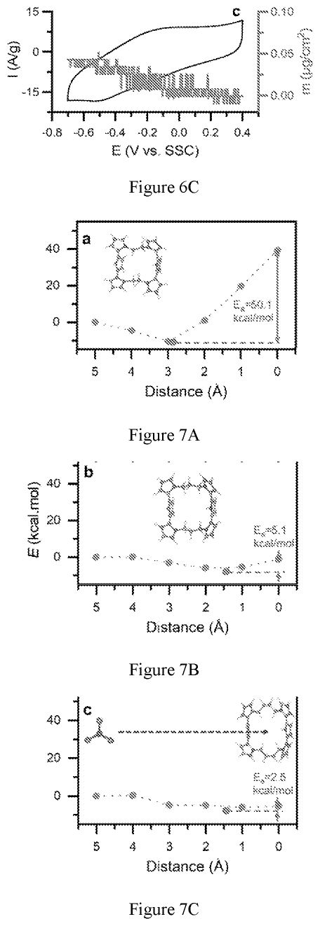

Based on this interpretation, it was of interest to examine whether anions within Ppy-Et are fully “trapped” in cages with no mobility, or mobile with low diffusivity from steric hindrance. To evaluate this, the electrochemical behavior of Ppy-Et was compared using CV at 10, 20, and 50 mV/s sweep rates. If nitrate anions were completely trapped in the polymer network upon crosslinking, it would not be expected to see any anion insertion behavior in EQCM results even at low sweep rates. However, if anions are still mobile but have restricted transport, it was expected nitrate insertion/extraction would be discernible at lower sweep rates, where the time between any two potentials is increased. FIG. 6A-6C compares mass and current for Ppy-Et films as the scan rate is increased from 10 to 20 to 50 mV/s. In FIG. 6A at a scan rate of 10 mV/s, a small mass increase was observed on the interval 0.0-0.4 V vs. SSC consistent with anion-insertion behavior. Although the mass change corresponding to anion insertion is much smaller here than for intrinsic Ppy (0.034(±0.010) ug/cm² at 10 mV/s for Ppy-Et vs. 0.173(±0.020) ug/cm² at 50 mV/s for the intrinsic Ppy) the positive slope of m vs. E on oxidation at this lowest sweep rate of 10 mV/s indicates that Et-crosslinking does not entirely immobilize anions within the Ppy structure, but allows for some anion-insertion at low sweep rates. When the sweep rate is increased to 20 mV/s, the mass curve flattens in this potential region, and no net gain mass is observed on the oxidizing sweep. This suggests that nitrate diffusion is hindered rather than halted by reaction with the crosslinker. It is noted that Ppy-Pr and Ppy-Bu exhibit qualitative responses consistent with anion insertion character (a region of positive slope of m vs. Q) at all sweep rates (not shown). This indicates that propyl crosslinker units are long enough to allow for more facile transport of nitrate through the film, albeit at a lower magnitude than intrinsic Ppy. This mechanism of sterically hindered anion transport within Ppy may also explain the minority cation-insertion behavior observed in intrinsic Ppy in FIGS. 2A-2D, 3A-3B, and 4, where during the stochastic formation of Ppy during electrodeposition, a small fraction of anions may become sterically trapped within the Ppy structure.

To confirm the proposed explanation that shorter crosslinker chain-lengths restrict nitrate transport, DFT calculations were performed to identify the energy barrier for a nitrate molecule traversing through pores formed by pyrrole crosslinked with different alkyl chain lengths in FIG. 7A-7C. For these DFT calculations, Ppy is represented by three-monomer chains linked on each end by alkyl ligands bridging amines. The resulting pore structures are depicted for Ppy-Et, Ppy-Pr, and Ppy-Bu in FIGS. 7A, 7B, and 7C, respectively. The distance of nitrate relative to the center of the pore (defined here as a position of 0 Å) was fixed and an energetic relaxation was performed at each fixed nitrate distance from 0-5 Å in 1 Å intervals, depicted schematically in FIG. 7C. In FIG. 7A for Ppy-Et, a complexation adduct of −10.9 kcal/mol was observed when nitrate is 2.86 Å from the Ppy-Et pore center, and an uphill energy of 39.2 kcal/mol when nitrate is fixed within the Ppy-Et pore at 0 Å was calculated. This corresponds to an activation energy (Ea) of 50.1 kcal/mol, and is consistent with restricted transport of nitrate observed in FIGS. 5A-5D and 6A-6C. In contrast, a three-carbon crosslinking chain length for Ppy-Pr in FIG. 7B and a four-carbon crosslinking chain length for Ppy-Bu in FIG. 7C provides a more ‘open’ polymer structure, in which nitrate anions readily transport through the pores formed by crosslinked Ppy chains. Order of magnitude lower Ea's of 5.1 and 2.5 kcal/mol were observed for Ppy-Pr and Ppy-Bu respectively (compared to 50.1 kcal/mol for Ppy-Et), meaning nitrate ions can more easily traverse the porous network and move freely between redox-active sites during potential cycling when propyl and butyl crosslinkers are used.

### Example 4: Effects of Structural Changes on Electrochemical Capacitance

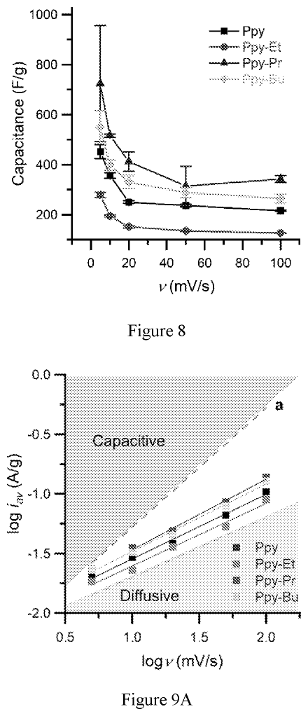

Considering the qualitative changes in anion transport behavior induced by crosslinking Ppy with different crosslinker chain lengths, it was expected that the resulting capacity and rate capability of Ppy would also be impacted. To test this, CV measurements were performed at sweep rates of 5, 10, 20, 50, and 100 mV/s in duplicate for 20 nm films and the resulting charge storage capacitances were reported in FIG. 8. While the capacitance of an ideal electrochemical capacitor should not be diffusion controlled (i.e. limited by the diffusing ion), pseudo-capacitors such as Ppy that rely on faradaic reactions can be limited by ion diffusion, and specific capacitance measurements therefore can provide valuable information on the rate capability of ion-uptake processes occurring during electrochemical cycles. Here, the capacitance of each film was calculated by integrating the current with respect to time over the anodic sweep and dividing through by the voltage range. The capacitance at each sweep rate was then scaled by dividing by the individual film mass determined by EQCM during deposition.

It was observed that the capacitance of Ppy-Et was 42% lower on average than that of Ppy. This is not surprising considering the above indication that the Et-crosslinker introduces steric hindrance for anion insertion/extraction. It was expected that this highly crosslinked polymer network also reduces the rate of cation transfer and limits the total realizable capacity at a fixed sweep rate. While one might expect that the capacitances of Ppy-Pr and Ppy-Bu would also be lower due to steric limitations to anion transport, surprisingly Ppy-Pr and Ppy-Bu exhibit significantly higher capacities than intrinsic Ppy, despite having a lower fraction of nitrate contribution to the overall mass change during CV (see FIG. 5A-5D). At a sweep rate of 10 mV/s, Ppy-Pr exhibits a specific capacitance of 516±7 F/g (157±2 mAh/g) and Ppy-Bu exhibits a specific capacity of 397±20 F/g (121±6 mAh/g). These values for Ppy-Pr and Ppy-Bu are 45% and 12% higher, respectively, than the value of 356±11 F/g (109±3 mAh/g) measured for intrinsic Ppy. At a sweep rate of 5 mV/s, the specific capacitance of Ppy-Pr is 723±230 F/g (221±70 mAh/g) vs. 452±29 F/g (138±9 mAh/g) for intrinsic electrodeposited Ppy, in line with a 60% increase in capacity. It is suggested that this increase in capacity using the propyl and butyl crosslinkers may arise because the crosslinkers open the pore structure to allow faster anion transport (as outlined in FIG. 7A-7C), and may also allow for storage of ions within the pore structures so as not to require diffusion of the ions in/out of the polymer structure during charging, in line with proton shuttling effects observed in polyaniline with diprotic acids. However, interestingly a decrease in capacitance was observed when increasing the crosslinker chain length from three (Ppy-Pr) to four (Ppy-Bu) carbons. The pore structure of Ppy-Bu would be expected to be more open than Ppy-Pr and therefore produce a higher current.

To more accurately quantify this behavior, the capacitive and diffusive portions of the current obtained during CV were separated using the constant phase element (CPE) model represented in Equation 4.

$$log {i}_{a v} = ( 1 - \frac{{f}_{d}}{2} ) log v + k \qquad ( 4 )$$

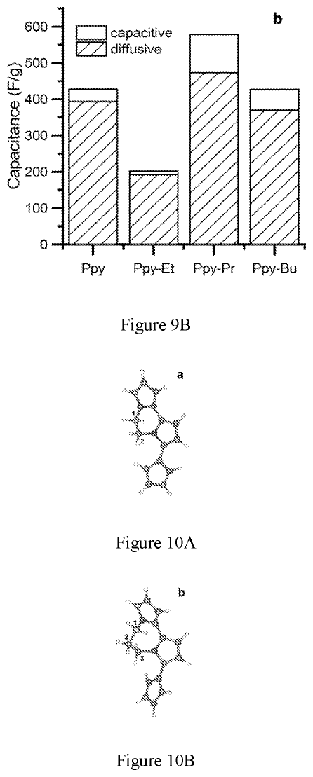

Here iₐᵥ is the average current (taken from the cathodic sweep), v is the scan rate, f_{d} is the fraction of capacitance limited by diffusion, and k is a constant determined by linear regression. For an ideal capacitor, f_{d}=0, and the slope of the log-log plot will be unity. If the electrochemical processes are entirely diffusion-limited, f_{d}=1, and the slope of the line will be ½. In FIG. 9A, log-log plots of average current and scan rate are presented. The fractions of diffusion-limited capacitance were calculated from the slope of the lines in FIG. 9A, and the results are presented in FIG. 9B. It was calculated that the amount of capacitive charge storage corresponds to 35 F/g (8% of total), 10 F/g (5% of total), 106 F/g (18% of total), and 57 F/g (13% of total) for intrinsic Ppy, Ppy-Et, Ppy-Pr, and Ppy-Bu, respectively. The capacitive charge storage for Ppy-Pr is higher in value than the capacitive charge storage measured for the other forms of Ppy studied here. The capacitive contribution to charge storage is roughly four times higher for Ppy-Pr than Ppy and three times higher for Ppy-Pr than Ppy-Bu. The current in Ppy-Et is almost entirely diffusion-controlled. These general trends correlate well with the EQCM data shown in FIG. 5A-5D, the energies/structures shown in FIG. 7A-7C, and the capacitance measurements shown in FIG. 8. In total, these results describe that the ethyl crosslinker restricts ion transport and limits capacity, whereas a propyl crosslinker opens the polymer pore structure to provide (1) more facile transport of ions, (2) space for ions to reside within the polymer matrix without diffusing in/out of the structure during charging, and (3) access for ions to coordinate with more of the redox-active sites on Ppy and enhance the electrochemical capacity. However, based on this interpretation and the structures presented in FIG. 7A-7C, more rapid charge storage and higher capacities would be expected in Ppy-Bu than in Ppy-Pr. The higher fraction of diffusion limitation in Ppy-Bu in FIG. 9B suggests that the butyl crosslinker does not open the polymer pores to the extent depicted in FIG. 7C, which helps explain the lower capacity observed for Ppy-Bu vs. Ppy-Pr.

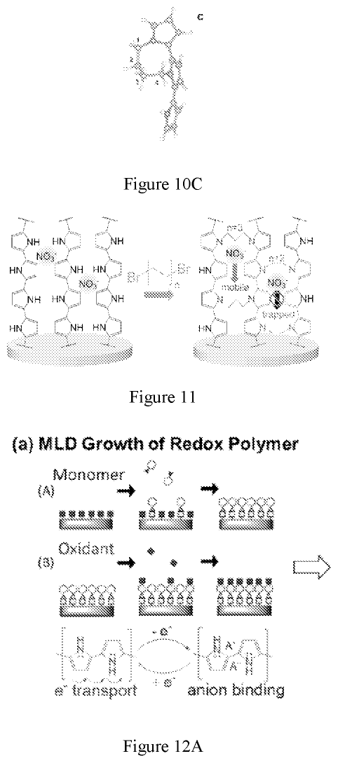

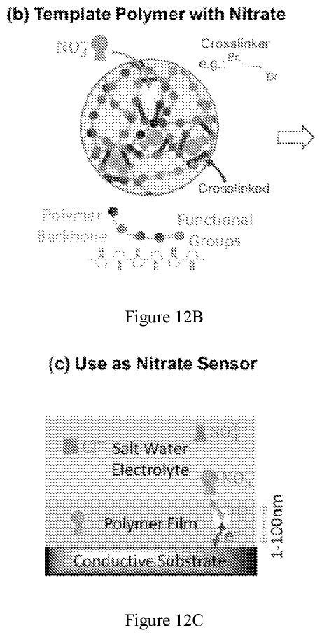

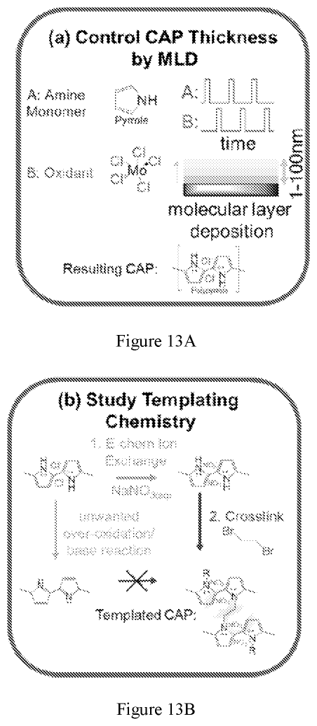

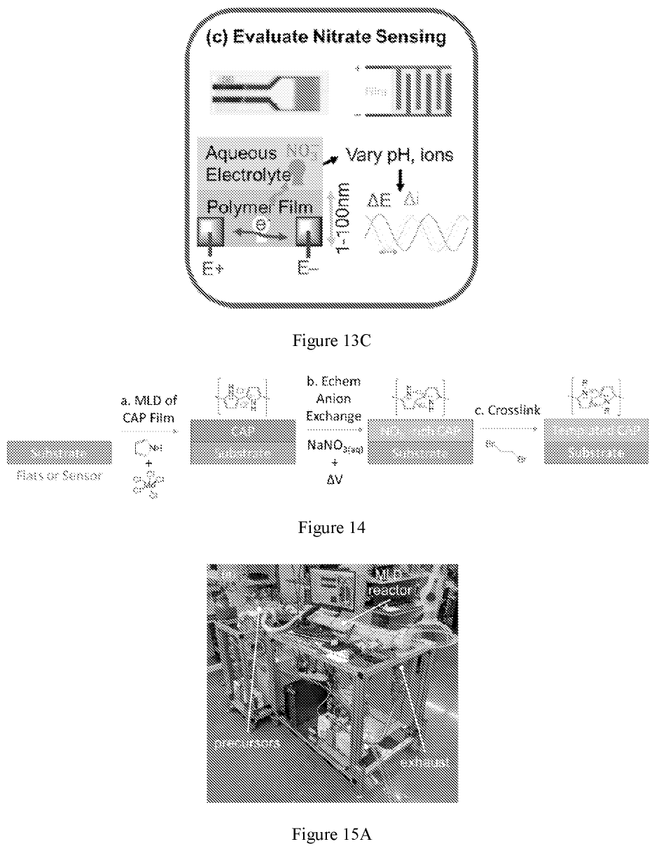

It is proposed that the lower and diffusion-limited capacity of Ppy-Bu vs. Ppy-Pr arises because of the higher number of conformational degrees of freedom of the Bu crosslinker, allowing the BuBr₂ to react in different ways across Ppy chains, producing smaller pores and/or not expanding the space between adjacent Ppy chains. As an example of this, DFT calculations were performed of the enthalpy for reaction of each crosslinker reacting with two adjacent amines on the same Ppy chain (intrachain) in FIG. 10A-10C. Here, the final relaxed structures of one Ppy chain reacting with EtBr₂ (FIG. 10A), PrBr₂ (FIG. 10B), and BuBr₂ (FIG. 10C) are depicted. Of the three alkyl dihalides, intrachain reaction with EtBr₂ is expected to be the least energetically favorable, as it introduces tortional strain on the Ppy and Et molecular structures. Increasing the crosslinker chain length from two carbons (FIG. 10A) to three carbons (FIG. 10B) and four carbons (FIG. 10C) is expected to reduce molecular strain because the different conformational configurations accessible by butyl crosslinkers place the reacting nitrogens furthest apart compared to ethyl crosslinkers. One can visually identify that the tortional strain along the Ppy backbone is lower in FIG. 10C than in FIGS. 10B and 10A. Indeed, the calculated reaction energies support this hypothesis, yielding values of −126 kcal/mol, −132 kcal/mol, and −144 kcal/mol for the intrachain reaction of Ppy with EtBr₂, PrBr₂, and BuBr₂, respectively. Based on this trend toward more exothermic reaction energy with longer crosslinker chain length within this same reaction family, based on the Evans-Polanyi principle it is expected that the activation energy will be highest for the intrachain EtBr₂ reaction, and lowest for the intrachain BuBr₂ reaction. It was also noted that steric effects and a constrained molecular structure in the environment surrounding isolated polymer chains within the actual Ppy molecular structure would introduce additional energetic barriers to the torsion necessary to access the structure depicted in FIG. 10A-10C. It was expected from this analysis that a larger portion of the butyl crosslinker reacts on a single polymer chain relative to ethyl and propyl crosslinkers. This would lead to the formation of fewer open pores (like those depicted FIG. 7C) through the polymer matrix using the BuBr₂ crosslinker relative to the PrBr₂ crosslinker, and explain the lower capacitance and rate capability for Ppy-Bu relative to Ppy-Pr in FIGS. 8 and 9A-B.

Methods and Procedures

The proposed templating procedure involves a three-step chemical synthesis process as depicted in FIG. 14. The ultimate nitrate sensing performance is expected to depend on the reaction conditions employed in each chemical step. How the reaction conditions in each chemical step influence the polymer molecular structure and in turn the nitrate sensing performance will be studied. One critical parameter during synthesis is the concentration of secondary amines (R₂—N—H) in the polymer. These secondary amines are needed for electrochemical nitrate binding and to act as anchors for crosslinking reactions to form nitrate-specific sites in the polymer. How the electrochemical nitrate impregnation procedure (e.g. pH, applied bias, and reaction time) impacts the concentration of secondary amines and the extent of nitrate infiltration in polymer will be studied. How the pH and concentration of the crosslinking solution influence the quantity of secondary amines within the redox-active polymer structure and ultimately impact selectivity toward nitrate will also be evaluated.

Molecular layer deposition (MLD) (FIG. 14) will be employed for polymer synthesis to covalently bond conformal thin polymer films to the substrate and provide sub-nanometer thickness control. The use of MLD also allows one to study and understand how the thickness of the polymer film used for sensing impacts the sensing performance. The thickness of the polymer used for nitrate sensing is a critical parameter because it is connected with physical properties that drive sensor performance. For example, thinner (˜1 nm) polymer films are expected to improve electrical connectivity to the nitrate-binding sites in the polymer, but thinner polymers will contain fewer nitrate selective sites on the whole and may allow for only limited conformational configurations in the polymer, thereby reducing nitrate selectivity. Conversely, for very thick (≥100 nm) polymer films, the response times are expected to be slower than for thin polymers because of slow diffusion of nitrate into the polymer. Additionally, the electrical resistance is expected to be higher for thicker polymer films, reducing nitrate measurement accuracy. The proposed work will test these hypotheses and establish understanding of how polymer thickness impacts the nitrate binding mechanism and nitrate detection sensitivity. These fundamental insights will be used to inform procedures for generating nitrate sensors with improved sensitivity and selectivity.

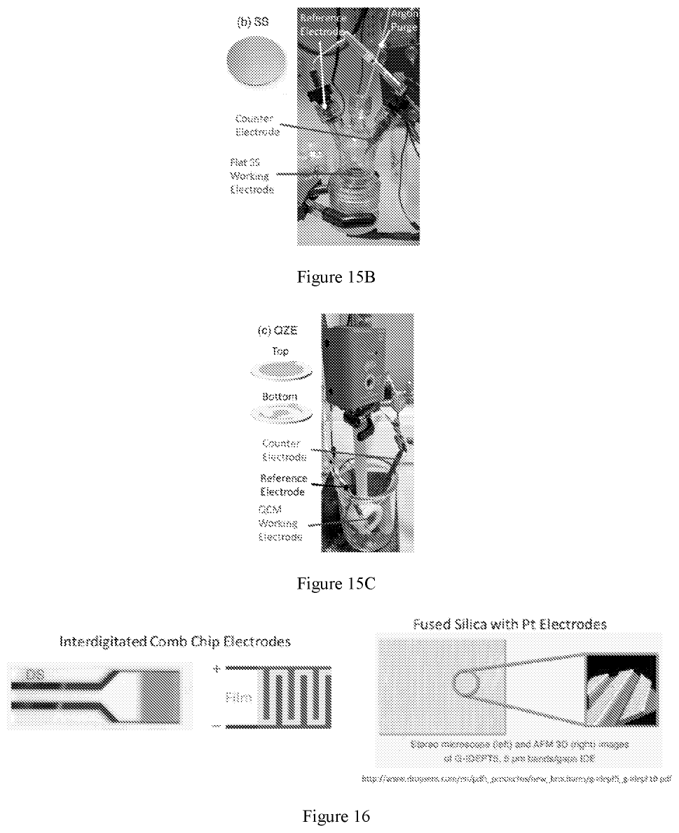

Tasks will be performed using an MLD reactor as depicted in FIG. 15A. QZE and SS samples (depicted in FIG. 15B and FIG. 15C) will be loaded into the reactor body on a sample tray. Following deposition, these samples will be studied ex situ using FTIR, SE, and electrochemical characterization to confirm CAP deposition. SE and literature models of CAP films will be employed to model the thickness and optical properties of the CAP films and benchmark these results against XRR measurements to confirm the formation of target film thickness. Ex situ FTIR will also be employed to characterize the local atomic environments of N and C in the MLD films and confirm CAP formation. Additionally, CV of the CAP films on SS substrates will be performed using three-electrode measurements in a custom electrochemical cell as depicted in FIG. 15B to confirm that the electrochemical behavior is consistent with the target CAP films.

In operando EQCM will be performed using the cell depicted in FIG. 15C. The QZE substrates act as the working electrode during EQCM to provide sub-nm mass sensitivity during chemical and electrochemical steps. The use of EQCM will allow for the rapid testing of hypotheses and to build a general understanding of the reaction behavior and relevant reaction parameters that affect nitrate templating. QZE electrodes enable in operando detection of submonolayer mass changes on the QZE surface in liquid solutions by monitoring changes in the piezoelectric resonant frequency of the electrodes. EQCM will be used to measure mass changes of ions/molecules binding and releasing from the CAP films during electrochemical cycling, and during the crosslinking reaction. These data will enable understanding of the extent of crosslinking and to determine the amount of ions binding per unit mass to establish specific ion binding capacity and understand how many binding sites are available in the templated polymer.

The understanding gained during previous steps will be confirmed by performing ex situ characterization on SS substrates following templating to confirm the observations from EQCM experiments. The templating reaction parameters will be adjusted based previous results and evaluate the electrochemical behavior of the templated CAP films in single salt electrolytes containing e.g. NaNO₃, NaCl, Na₂SO₄, and Na₂CO₃ to confirm selective binding of nitrate over other negative ions. Electrochemical measurements using SS substrates will be performed to measure how the electrochemical capacity and equilibrium potentials vary with the electrolyte anion. Electrochemical measurements will also be performed on templated CAP films in varying electrolytes using QZE substrates with EQCM to measure mass changes and confirm that the electrochemical capacity observed with SS substrates corresponds to anion insertion.

Then, the previously established chemistries will be used to comb chip electrodes and benchmark these comb chip electrodes as nitrate sensors. The comb chip electrodes to be employed are commercially available, and consist of interdigitated electrodes 5 μm electrodes with 5 μm gaps between the electrode fingers as depicted in FIG. 16. The high surface area of these electrodes provides a 600,000-fold increase in interplanar surface area over a flat sandwich cell of the same area, and is expected to enhance the nitrate-detection signal of these electrodes. Because these comb chip electrodes have a 3D structure, SE or XRR will be unable to be performed to verify the presence of the CAP film following MLD. Instead, FIB-SEM will be performed to verify the presence of the CAP film conformally on the comb-chip fins. Following this initial deposition of the templated CAP polymer, electrical characterization will be performed on a dry electrode to confirm electrical conductivity of the CAP film. The sensitivity to nitrate and selectivity toward nitrate will then be studied. Finally, the performance of templated CAP comb chip electrodes will be evaluated in field samples of Missouri water in collaboration with CERC at USGS.

### Example 7: Nitrate Sensing

Polyaniline (PANT) samples used in FIGS. 18-22 were deposited on stainless-steel electrodes from a solution of 0.1 M aniline monomer with 1 M sulfuric acid supporting electrolyte. Films were electropolymerized using a pulsed potential technique, in which a 0.8 V oxidizing potential was applied for 1.5 seconds, followed by a relaxation pulse at open-circuit for 1.5 seconds for 40 repeat cycles. The solutions were purged with argon gas prior to and during electrodeposition. Newly deposited PANI films were doped with nitrate by charging the films at 0.4 V vs. Ag/AgCl for 300 seconds in a solution of nitric acid. Films were then crosslinked with dibromoethane in methanol before performing CV.

FIG. 18 depicts the results of CV in 0.1M NaNO₃ (pH=8) at a scan rate of 50 mV/s. The rapid performance decay is possibly the result of a poor degree of alkylation, as the doping/de-doping of substituted nitrogen should not require proton binding.

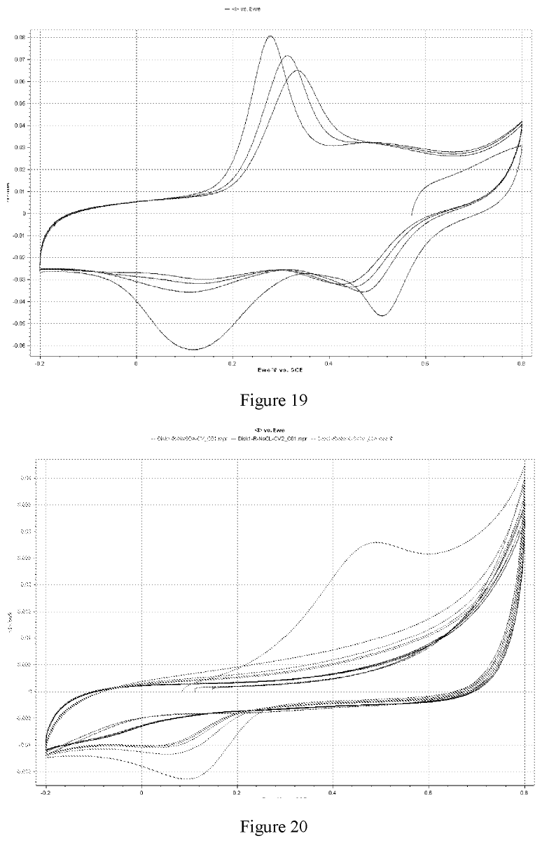

FIG. 19 shows a CV at 50 mV/s and depicts how addition of a small amount of HNO₃ to the NaNO₃ solution drastically increases the current response. This could indicate that many of the target nitrogens were not alkylated as intended, given that proton binding seems to be driving the majority of the electrochemical process.

FIG. 20 depicts CV's at 50 mV/s in 0.1 M NaNO₃, 0.1 M NaCl, and 0.1 M Na₂SO₄ at approximately neutral pH. The film shows a preference for nitrate over chloride and sulfate evidenced by the higher observed current in nitrate solution. Here nitrate is green, chloride is black, and sulfate is blue.

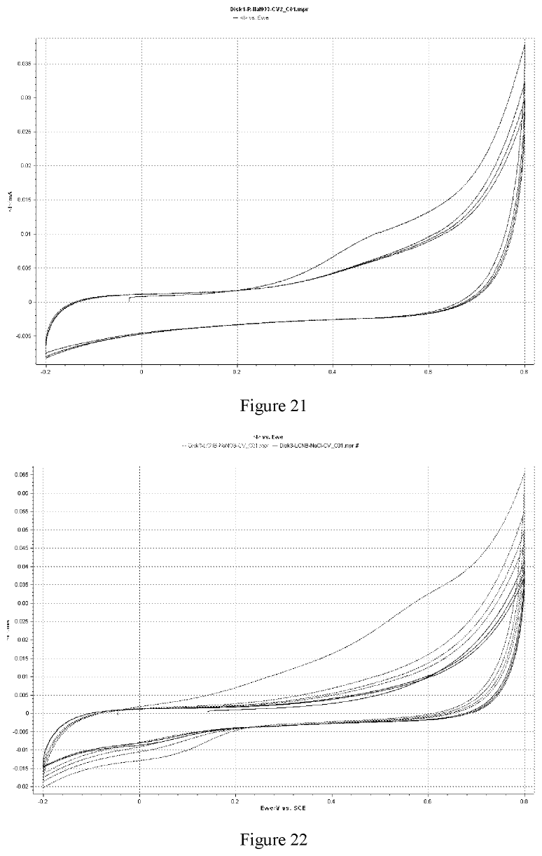

FIG. 21 depicts a CV at 50 mV/s of the film in 0.1 M NaNO₃ after it has been cycled in nitrate, acidified nitrate, chloride, and sulfate solutions. Film response is reduced significantly; however, the observed current is still greater than that observed in solutions of interfering anions.

FIG. 22 depicts how removal of base from the reaction mixture appears to reduce film performance. However, the film still preferentially selects nitrate over chloride and sulfate.

### Example 8: Improved Capacity and Cycling Stability of Solution-Cast Polyaniline

Polyaniline (PANI) was solution-cast on gold electrodes from a 10 wt % solution of PANI-DNNSA dissolved in xylene. After deposition, the films were dried in an oven at 50° C. for 10 minutes. Films were then treated by rinsing with 2 wt % pTSA:BuOH solution for 1 minute, followed by a second drying step at 50° C. for 10 minutes. Select treated polymer films were crosslinked in a solution of 100 of dibromopropane in 10 mL of acetone for 10 minutes, followed by acetone rinsing and a third drying step at the same temperature and time as previous. Material thicknesses were measured using spectroscopic ellipsometry (SE), and polymer weights were calculated based on a PANI density of 1.5 g/cm³. The stability and capacity of uncrosslinked and crosslinked PANI films was determined by cyclic voltammetry (CV), which was performed in 1 M sulfuric acid solution with a scan rate of 50 mV/s and a voltage window of −0.2-0.8 vs. Ag/AgCl reference.

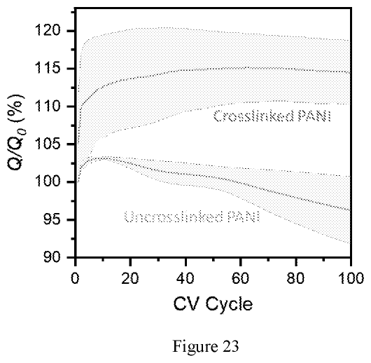

The effects of 100 repeat CV cycles on two uncrosslinked and two crosslinked films are shown in FIG. 23, where the y-axis (Q/Q₀) is the ratio of the mass specific charge capacity of the n^{th} CV cycle divided by the charge capacity of the 1st CV cycle of the uncrosslinked PANI control.

As shown in FIG. 23, an increase in both capacity and stability is observed for the films crosslinked with dibromopropane.

1. An electrochemical device comprising a conductive substrate coated with a film comprising a conducting polymer crosslinked with a linker, wherein the conducting polymer film comprises an ion, and a branched network having pores.

2. The electrochemical device of claim 1, wherein the conducting polymer is derived from a monomer having a double bond and a heteroatom.

3. The electrochemical device of claim 2, wherein the heteroatom is oxygen, sulfur or nitrogen.

4. The electrochemical device of claim 1, wherein the conducting polymer comprises polypyrrole, polyaniline, polythiophene, poly(3,4-ethylenedioxythiophene) (PEDOT), poly(phenylenediamine), poly(benzene-triamine), polyethylenediamine, polyhydroquinone, polybenzoquinone, polybenzenethiol, polybenzenedithiol, polybenzenetrithiol, polyfuran, or a combination thereof.

5. The electrochemical device of claim 1, wherein the conducting polymer comprises polypyrrole.

6. The electrochemical device of claim 1, wherein the conducting polymer comprises polyaniline.

7. The electrochemical device of claim 1, wherein the linker comprises a C₂-C₈ compound comprising single, double, or triple bond, or a combination thereof, and optionally a heteroatom.

8. The electrochemical device of claim 7, wherein the heteroatom is oxygen, sulfur, or nitrogen.

9. The electrochemical device of claim 1, wherein the linker comprises an alkylene or an arylene moiety.

10. The electrochemical device of claim 1, wherein the linker comprises an alkylene moiety.

11. (canceled)

12. The electrochemical device of claim 10, wherein the alkylene moiety comprises ethylene, propylene, butylene, or a combination thereof.

13. The electrochemical device of claim 10, wherein the alkylene moiety comprises ethylene or propylene.

14.-19. (canceled)

20. The electrochemical device of claim 1, wherein the film is from about 20 nm to about 80 nm thick.

21.-22. (canceled)

23. The electrochemical device of claim 1, wherein the ion is an anion and the anion comprises nitrate, chloride, fluoride, bromide, iodide, phosphate, acetate, arsenate, perchlorate, sulfate, glyphosate, hexafluorophosphate, tetrafluoroborate, bis(fluorosulfonyl)imide (FSI), bis(trifluoromethylsulfonyl)imide (TFSI), or a combination thereof or wherein the ion is a cation and the cation comprises sodium, lithium, potassium, protons, magnesium, calcium, aluminum, ammonium, alkylated ammonium cations, zinc, copper, manganese, iron, cobalt, nickel, tin, strontium, another monovalent, divalent, or trivalent transition metal cation, or a combination thereof.

24.-27. (canceled)

28. The electrochemical device of claim 1, wherein the conductive substrate comprises gold, platinum, silver, copper, nickel, carbon, carbon fiber, graphite, stainless steel, aluminum, steel, titanium, vitreous carbon, carbon black, activated carbon, pyrolytic graphite, palladium, zinc, lithium metal, sodium metal, potassium metal, or a combination thereof.

29. (canceled)

30. The electrochemical device of claim 1, wherein the electrochemical device is an electrode, a cathode, a battery, or a supercapacitor.

31.-33. (canceled)

34. An ion sensor comprising the electrochemical device of claim 1.

35. The ion sensor of claim 34, wherein the ion is an anion and comprises nitrate, phosphate, arsenate, pertechnetate, uranate, glyphosate, perfluorooctylsulfate (PFOS), or perfluorooctanoate (PFOA) or wherein the ion is a cation and comprises sodium, lithium, potassium, or another monovalent cation.

36.-37. (canceled)

38. The ion sensor of claim 34, wherein the electrochemical device is a comb-chip electrode.

39. A method of producing the electrochemical device comprising the conductive substrate coated with the film comprising the conducting polymer crosslinked with the linker of claim 1, the method comprising:
preparing a solution of a conducting monomer and an anion in deionized water;
electrodepositing the conducting monomer as a film on the conductive substrate; and
reacting the film with a crosslinker.

40.-46. (canceled)
